(19) United States
(12) Patent Application Publication
(10) Pub. No.: US 2016/0298018 A1
(43) Pub. Date: Oct. 13, 2016

(54) METHODS FOR TREATING SUBTERRANEAN FORMATIONS

(71) Applicants: Anatoly Vladimirovich MEDVEDEV, Moscow (RU); SCHLUMBERGER TECHNOLOGY CORPORATION, Sugar Land, TX (US); SCHLUMBERGER TECHNOLOGY B.V., The Hague (NL)

(72) Inventors: Anatoly Vladimirovich Medvedev, Moscow (RU); Nikita Yurievich Silko, Novosibirsk (RU)

(21) Appl. No.: 15/038,643

(22) PCT Filed: Nov. 26, 2013
(86) PCT No.: PCT/RU2013/001059

§ 371 Date: May 23, 2016

(51) Int. Cl. C09K 8/514; E21B 33/138; E21B 21/00; C09K 8/504

(52) U.S. Cl. CPC C09K 8/514; C09K 8/5045; E21B 33/138; E21B 21/003; C09K 2208/08

(57) ABSTRACT

Fluid compositions comprising water, at least one water soluble polymer, degradable particles or nondegradable particles or both, and degradable fibers have utility as temporary lost circulation prevention systems. The compositions may be placed in a borehole such that they contact perforations, formation cracks, fissures, vugs or combinations thereof. The compositions form a plug or filtercake that minimizes flow between the wellbore and the formation. After completion of the well operation, the fibers degrade and the plug or filtercake weakens and may be washed away, thereby reestablishing fluid flow between the wellbore and the formation.

### BACKGROUND

The statements in this section merely provide background information related to the present disclosure and may not constitute prior art.

The present disclosure broadly relates to methods for temporarily controlling flow between a wellbore and a subterranean formation.

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Fluid compositions used for these various purposes may be water- or oil-based and may comprise weighting agents, surfactants, proppants, or polymers. However, for a wellbore fluid to perform all of its functions and allow wellbore operations to continue, the fluid must stay in the borehole. Frequently, undesirable formation conditions are encountered in which substantial amounts or, in some cases, practically all of the wellbore fluid may be lost to the formation. For example, wellbore fluid can leave the borehole through large or small fissures or fractures in the formation or through a highly porous rock matrix surrounding the borehole.

Lost circulation is a recurring drilling problem, characterized by loss of drilling mud into downhole formations. It can occur naturally in formations that are fractured, highly permeable, porous, cavernous, or vugular. These earth formations can include shale, sands, gravel, shell beds, reef deposits, limestone, dolomite, and chalk, among others. Other problems encountered while drilling and producing oil and gas include stuck pipe, hole collapse, loss of well control, and loss of or decreased production.

Lost circulation may also result from induced pressure during drilling. Specifically, induced mud losses may occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighboring or inter-bedded low permeability rocks, such as shales, maintain their pore pressure. This can make the drilling of certain depleted zones impossible because the mud weight required to support the shale exceeds the fracture pressure of the sands and silts.

Fluid losses are generally classified in four categories. Seepage losses are characterized by losses of from about 0.16 to about 1.6 m³/hr (about 1 to about 10 bbl/hr) of mud. They may be confused with cuttings removal at the surface. Seepage losses sometimes occur in the form of filtration to a highly permeable formation. A conventional LCM, particularly sized particles, is usually sufficient to cure this problem. If formation damage or stuck pipe is the primary concern, attempts are generally made to cure losses before proceeding with drilling. Losses greater than seepage losses, but less than about 32 m³/hr (about 200 bbl/hr), are defined as partial losses. In almost all circumstances when losses of this type are encountered, regaining full circulation is required. Sized solids alone may not cure the problem. When losses are between about 32-48 m³/hr (200-300 bbl/hr), they are called severe losses, and conventional LCM systems may not be sufficient. Severe losses particularly occur in the presence of wide fracture widths. As with partial losses, regaining full circulation is required. If conventional treatments are unsuccessful, spotting of LCM or viscous pills may cure the problem. The fourth category is total losses, when the fluid loss exceeds about 48 m³/hr (about 300 bbl/hr). Total losses may occur when fluids pumped past large caverns or vugs. In this case, the common solution is to employ cement plugs and/or polymer pills, to which LCM may be added for improved performance. An important factor, in practice, is the uncertainty of the distribution of zones of these types of losses, for example, a certain size fracture may result in severe loss or total loss depending on the number of such fractures downhole.

The use of fibers and solids to prevent lost circulation during drilling operations has been widely described. Such fibers include, for example, jute, flax, mohair, lechuguilla fibers, synthetic fibers, cotton, cotton linters, wool, wool shoddy, and sugar cane fibers. One known process for preventing or treating lost circulation involves the addition, at concentrations ranging between about 1.43 and about 17.1 kg/m³ of water-dispersible fibers having a length between about 10 and about 25 mm, for instance glass or polymer fibers, to a pumped aqueous base-fluid including solid particles having an equivalent diameter of less than about 300 microns. Another known process utilizes melt-processed inorganic fibers selected from basalt fibers, wollastonite fibers, and ceramic fibers. Such known methods and compositions, however, typically require large amounts of fibers.

Frequently the formation intervals through which lost circulation occurs are also producers of the valuable resources to be extracted from the well. Therefore, it may be beneficial to have means for removing the aforementioned barriers to fluid movement after well completion, thus improving well productivity.

### SUMMARY

The present disclosure reveals compositions and methods by which escape of wellbore fluids into subterranean formations may be temporarily minimized or prevented.

In an aspect, embodiments relate to methods for temporarily blocking fluid flow through at least one pathway in a subterranean formation penetrated by a wellbore. A composition is prepared that comprises water, at least one water soluble polymer, degradable particles or nondegradable particles or both, and degradable fibers. The composition is allowed to flow into perforations, cracks, fissures, vugs or a combination thereof in the formation, thereby forming a filtercake or plug or both that restricts further flow of the composition into the formation. The fibers are then allowed to degrade, thereby causing the plug or filtercake or both to weaken. The plug or filtercake or both are removed, thereby reestablishing fluid movement between the wellbore and the formation.

In a further aspect, embodiments relate to methods for controlling the movement of fluids in a subterranean well having a borehole. A composition is prepared that comprises water, at least one water soluble polymer, degradable particles or nondegradable particles or both, and degradable fibers. The composition is allowed to flow into perforations, cracks, fissures, vugs or a combination thereof in the formation, thereby forming a filtercake or plug or both that restricts further flow of the composition into the formation. The fibers are then allowed to degrade, thereby causing the plug or filtercake or both to weaken. The plug or filtercake or both are removed, thereby reestablishing fluid movement between the wellbore and the formation.

### BRIEF DESCRIPTION OF THE DRAWINGS

FIG. 1 shows a schematic diagram of the lost-circulation testing apparatus used in the foregoing examples.

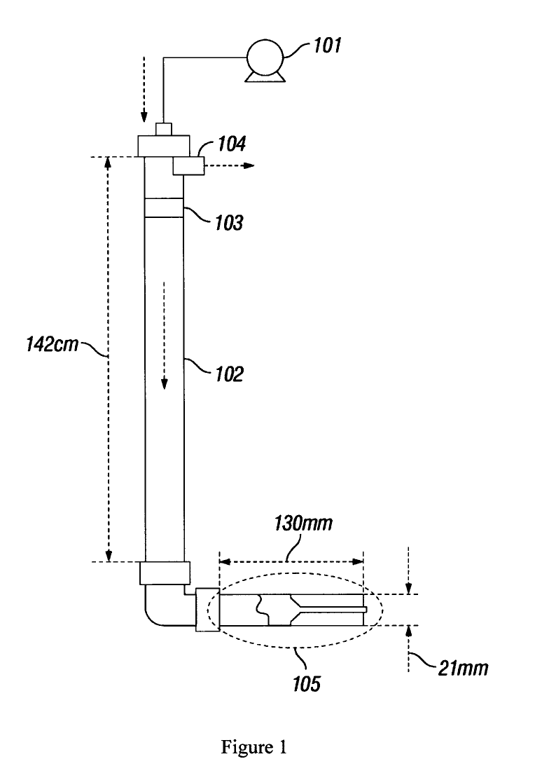

FIG. 2 shows a magnified view of a cylinder in which a slot has been cut. The slot simulates an opening in the formation rock of a subterranean well.

FIG. 3 shows a pressure versus time plot indicating the formation of a fiber plug in the slot of FIG. 2.

FIG. 4 shows a schematic diagram of a laboratory-scale testing unit that evaluates the ability of a fiber laden fluid to bridge across a screen.

FIG. 5 shows a schematic diagram of a laboratory-scale testing unit that evaluates the degradation behavior of fiber laden compositions described in the present disclosure.

FIG. 6 is a plot showing the effect of fiber degradation on the permeability of a plug versus time.

### DETAILED DESCRIPTION

Although the following discussion emphasizes blocking fractures encountered during drilling, the fibers and methods of the disclosure may also be used during cementing and other operations in which fluid loss or lost circulation are encountered. The disclosure will be described in terms of treatment of vertical wells, but is equally applicable to wells of any orientation. The disclosure will be described for hydrocarbon-production wells, but it is to be understood that the disclosed methods can be used for wells for the production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the Applicants appreciate and understand that any and all data points within the range are to be considered to have been specified, and that the Applicants have possession of the entire range and all points within the range.

The applicants have determined that an effective temporary barrier to lost circulation may comprise a composition comprising water, a water soluble polymer, particles and degradable fibers. The composition minimizes the flow of wellbore fluids into perforations, cracks, fissures, vugs or combinations thereof, thereby facilitating normal well completion operations.

The combination of fibers and particles in the composition may improve the efficiency of plug or filtercake formation. During placement in the wellbore, the fibers and particles may accumulate in perforations or cracks, fissures, vugs or combinations thereof in the formation. The accumulation forms an impermeable plug or filtercake that resists further fluid movement. Once in place, the plug or filtercake remains impermeable until the wellbore operation is completed. The fibers may then degrade with time, and the plug or filtercake may weaken, allowing operators to wash the plug or filtercake away. Flow between the wellbore and the formation is reestablished and production may resume. The composition may be nondamaging to the formation. The fiber degradation time may be shortened by including a degradation accelerant in the fluid or circulating the accelerant past the plug or filtercake, thereby saving valuable rig time and reducing costs.

In an aspect, embodiments relate to methods for temporarily blocking fluid flow through at least one pathway in a subterranean formation penetrated by a wellbore. A composition is prepared that comprises water, at least one water soluble polymer, degradable particles or nondegradable particles or both, and degradable fibers. The composition is allowed to flow into perforations, cracks, fissures, vugs or a combination thereof in the formation, thereby forming a filtercake or plug or both that restricts further flow of the composition into the formation. The fibers are then allowed to degrade, thereby causing the plug or filtercake or both to weaken. The plug or filtercake or both are removed, thereby reestablishing fluid movement between the wellbore and the formation.

In a further aspect, embodiments relate to methods for controlling the movement of fluids in a subterranean well having a borehole. A composition is prepared that comprises water, at least one water soluble polymer, degradable particles or nondegradable particles or both, and degradable fibers. The composition is allowed to flow into perforations, cracks, fissures, vugs or a combination thereof in the formation, thereby forming a filtercake or plug or both that restricts further flow of the composition into the formation. The fibers are then allowed to degrade, thereby causing the plug or filtercake or both to weaken. The plug or filtercake or both are removed, thereby reestablishing fluid movement between the wellbore and the formation.

For both aspects, the water may be fresh water. The fresh water may also contain clay stabilizers such as potassium chloride, tetramethyl ammonium chloride and the like. The water may also be free of bacteria and enzymes that could cause polymer degradation and premature viscosity loss.

For both aspects, the water soluble polymer may comprise one or more of the following materials: guar, hydroxypropyl guar, carboxymethylhydroxyethylguar, methylcellulose, ethylcellulose, hydroxyethylcellulose, hydroxypropylcellulose, xanthan gum, diutan gum or polyacrylamide of combinations thereof. The polymer molecular weight and concentration may be selected such that the viscosity of the solution may be between 33 cP and 58 cP @ 511 s⁻¹ (300 RPM reading on Fann 35 rotational viscometer, using R1B1 rotor-bob combination) at the wellbore temperatures where the plugs or filtercakes are placed. Or the solution viscosity may be between 38 cP and 48 cP @ 511 s⁻¹, or between 39 cP and 44 cP @ 511 s⁻¹.

For both aspects, the particles may be granular, lamellar or both. The particle concentration in the composition may be between 47 kg/m³ and 603 kg/m³. The particles may be selected from calcium carbonate, nut shells, plastics, sulfur, expanded perlite, cottonseed hulls, or cellophane flakes or combinations thereof. The particles may be degradable, comprising substituted and unsubstituted lactide, glycolide, polylactic acid (D isomer, L isomer or both), polyglycolic acid, a copolymer of polylactic acid and polyglycolic acid, a copolymer of glycolic acid with other hydroxy-, carboxylic acid-, or hydroxycarboxylic acid-containing moieties, a copolymer of lactic acid with other hydroxy-, carboxylic acid or hydroxycarboxylic acid-containing moieties, hydroxyacetic acid (glycolic acid) with itself or other hydroxy-, carboxylic acid-, or hydroxycarboxylic acid-containing moieties, polyvinyl alcohol, polyamide or polyethyleneterephtalate or combinations thereof. The particles may have an average particle size (d₅₀) between 20 micrometers and 500 micrometers, or between 50 micrometers and 250 micrometers, or between 80 and 130 micrometers. The particles may also be present in at least two discrete granulometric groups, each group having a different d₅₀. Such multimodal particle-size distributions may improve the packing efficiency of the particles and enhance the strength and durability of the plug or filtercake.

For both aspects, the fibers may comprise substituted and unsubstituted lactide, glycolide, polylactic acid, polyglycolic acid, a copolymer of polylactic acid and polyglycolic acid, a copolymer of glycolic acid with other hydroxy-, carboxylic acid-, or hydroxycarboxylic acid-containing moieties, a copolymer of lactic acid with other hydroxy-, carboxylic acid or hydroxycarboxylic acid-containing moieties, hydroxyacetic acid (glycolic acid) with itself or other hydroxy-, carboxylic acid-, or hydroxycarboxylic acid-containing moieties, polyvinyl alcohol, polyamide or polyethyleneterephtalate or combinations thereof . . . One chooses the appropriate fibers depending on the anticipated well temperature. For example, polylactic acid and polyvinylalcohol fibers may be selected for well temperatures below about 85° C. Other fibers in the list may be suitable for use at temperatures up to 200° C. or higher. During placement, the fibers may pass through a drill bit and remain intact.

The polymer fibers may have a variety of configurations. As used herein, the term “fiber” is meant to include fibers as well as other particulates that may be used as or function similarly to fibers for the purposes and applications described herein, unless otherwise stated or as is apparent from its context. These may include various elongated particles that appear as fibers or are fiber-like. The fibers or particulates may be straight, curved, bent or undulated. Other non-limiting shapes may include generally spherical, rectangular, polygonal, etc. The fibers may be formed from a single particle body or multiple bodies that are bound or coupled together. The fibers may be comprised of a main particle body having one or more projections that extend from the main body, such as a star-shape. The fibers may be in the form of platelets, disks, rods, ribbons, etc. The fibers may also be amorphous or irregular in shape and be rigid, flexible or plastically deformable. Fibers or elongated particles may be used in bundles. A combination of different shaped fibers or particles may be used and the materials may form a three-dimensional network within the fluid with which they are used. For fibers or other elongated particulates, the particles may have a length of less than about 1 mm to about 30 mm or more. In certain embodiments the fibers or elongated particulates may have a length of 12 mm or less with a diameter or cross dimension of about 200 microns or less, with from about 9 microns to about 300 microns being typical. For elongated materials, the materials may have a ratio between any two of the three dimensions of greater than 5 to 1. In certain embodiments, the fibers or elongated materials may have a length of greater than 1 mm, with from about 1 mm to about 30 mm, from about 2 mm to about 25 mm, from about 3 mm to about 20 mm, being typical. In certain applications the fibers or elongated materials may have a length of from about 1 mm to about 10 mm (e.g. 6 mm). The fibers or elongated materials may have a diameter or cross dimension of from about 5 to 100 microns and/or a denier of about 0.1 to about 20, more particularly a denier of about 0.15 to about 6.

The polymers used in forming the degradable fibers may be used in conjunction with a fiber degrading accelerant. The fiber degrading accelerant facilitates degrading of the fibers at those temperatures in which the polymer fibers are used and can be any material that facilitates such degradation. The particular fiber degrading accelerant may be selected, designed and configured to provide a selected degradation rate at selected temperatures and conditions in which the fibers are to be used. For example, the fiber degrading accelerant may facilitate providing a fiber degradation rate of about 20%, 30%, 40%, 50%, 60%, 70%, 80%, 90% up to 100% fiber degradation by weight or less over a period of from about 1 day to about 8 weeks (56 days) at downhole temperature conditions. In certain applications, a degradation rate of from about 20% to about 40% by weight over a period of from about 1 day to about 56 days at downhole temperature conditions may be particularly useful. Typically, the fiber degrading accelerant will be a pH adjusting material, such as a base, an acid, or a base or acid precursor that forms bases or acids in situ. The fiber degrading accelerant may also be an oxidizer.

Those bases for use as the fiber degrading accelerant can be any base or base precursor that facilitates the desired controlled degradation of the polymer fibers under the conditions in which the fibers are employed. The base may be one that that provides a pH of about 11 or 12 or more in the fluids or environment surrounding the polymer fibers. The base may be that provided from a low solubility oxide or hydroxide that slowly dissolves in aqueous fluids used with the fibers at the formation temperatures for which the polymer fibers are employed. Non-limiting examples of such low solubility bases include calcium hydroxide, calcium oxide, magnesium hydroxide, magnesium oxide, zinc oxide, and combinations of these. In cases where the bases produce polyvalent ions, such as Ca²⁺ and Mg²⁺, it may be desirable to use fibers that do not degrade to form diacids such as nylon 6 and nylon 11. Bases that have higher solubility, such as sodium hydroxide, potassium hydroxide, barium hydroxide, lithium hydroxide, rubidium hydroxide, cesium hydroxide, and combinations of these, may also be used provided their effect on the polymers provides the desired delay or controlled degradation of the fibers. This may be facilitated by encapsulation or the use of other delayed release techniques.

The acids employed as the fiber degrading accelerant may be any acid or acid precursor that facilitates the desired controlled degradation or hydrolysis of the polymer fibers under the conditions in which the fibers are employed. These may be Lewis acids or Bronsted acids. The acid may provide a pH of about 3 or less in the fluids or environment surrounding the polymer fibers. The acid may be a low solubility acid that slowly dissolves in aqueous fluids used with the fibers at the formation temperatures. Non-limiting examples of such low solubility acids may include oleic acid, benzoic acid, nitrobenzoic acid, stearic acid, uric acid, fatty acids, and derivatives of these, and their combinations. Other acids having higher solubility, such as hydrochloric acid, citric acid, acetic acid, formic acid, oxalic acid, maleic acid, fumaric acid, etc. Other soluble organic acids may also be used. Such soluble acids may also be used provided their effect on the polymers provides the desired delay or controlled degradation of the fibers. This may be facilitated by encapsulation or the use of other delayed release techniques. Lewis acids of BF₃, AlCl₃, FeCl₂, MgCl₂, ZnCl₂, SnCl₂, and CuCl₂ may be also used.

Oxidizers may also be used as the fiber degrading accelerant. Oxidizers may have unique properties that may cause them to have dual functions. Non-limiting examples of suitable oxidizers include bromates, persulfates, nitrates, nitrites, chlorites, hypochlorites, perchlorites, and perborates, and combinations of these. Specific non-limiting examples of these materials include sodium bromate, ammonium persulfate, sodium nitrate, sodium nitrite, sodium chlorite, sodium hypochorite, potassium perchlorite, and sodium perborate. At temperatures where the oxidative half-life is sufficient, the oxidizers act as oxidizers and degrade the polymers through oxidation. At higher temperatures where their oxidative half-life is short, they may be reduced (generally by water) and turn into their acidic counterpart, thus lowering the fluid pH so that they create a pH-induced hydrolysis of the polymers. Thus, for example, persulfate may be reduced to sulfuric acid, which then hydrolyzes the polymers. The oxidizers may be selected to have low solubility in the aqueous fluids used with the polymer fibers at the temperatures the fibers are used. In other embodiments, the oxidizers may be readily soluble in such fluids but may be encapsulated or used with other delayed release techniques to delay or control release of the oxidizer.

Another fiber degrading accelerant includes other degradable polymers. The degradable polymers used as the fiber degrading accelerant are characterized in that they degrade more readily than the polymers at certain conditions, such as lower temperature, and they facilitate the degradation of the fibers. Such degradable polymers may degrade at a rate of at least 10 times faster than the polymers at the same environmental conditions. The degradation of the polymer may include degradation of the polymer into species that facilitate the degradation of the polymer fibers. These may be “polymeric acid precursors” that are typically solids at room temperature. The polymeric acid precursor materials may include the polymers and oligomers that hydrolyze or degrade in certain environments under known and controllable conditions of temperature, time and pH to release acids. The acids formed from such polymers may be monomeric acids but may also include dimeric acid or acid with a small number of linked monomer units that function similarly, for purposes of embodiments of the invention described herein, to monomer acids composed of only one monomer unit.

Non-limiting examples of such degradable polymers for use of the fiber degrading accelerant include polymers and copolymers of lactic acid, glycolic acid, vinyl chloride, phthalic acid, etc., and combinations of these. Polylactic acid (PLA) and polyglycolic acid (PGA) degrade to form the organic acids of lactic acid and glycolic acid, respectively. Polyvinyl chloride (PVC) degrades to form the inorganic acid of hydrochloric acid. Phthalic acid polymer materials may include polymers of terephthalic and isophthalic acid. Polyester and polyamide materials formed from diacids that degrade into acids at the desired rate and environmental conditions to form the fiber degrading accelerant may also be used.

The fiber degrading accelerant may be used with the polymer fibers in a number of different ways. In one embodiment, the accelerant is formed from a material that is merely intermixed in the treatment fluid or portion thereof with the polymer fibers and is selected to slowly release the fiber degrading accelerant within the treatment fluid in contact with the surrounding polymer fibers over time when at the temperature in which the polymers are to be employed, such as those formation temperatures previously discussed. Such fiber degrading accelerant materials are not encapsulated and may be selected so that they release the fiber degrading accelerant within the treatment fluid over a period of at least one (1) hour when at the formation temperature, more particularly from about one (1) hour to about 14 hours, still more particularly from about one (1) hour to about one (1) day. Such materials may include slowly dissolving bases, acids, oxidizers, and their precursors, such as the polymeric acid precursors, as has been discussed previously. The materials may be configured as solid particles, which may be granules, fibers and other particulate shapes and configurations. The size and shape may also facilitate the rate of release of the accelerant. For example, larger particle sizes and particles with smaller surface area may provide longer release times than smaller particles or those with larger surface areas. A combination of different sized and configured particles may also be used. Those degradable polymers formed from polymeric acid precursors previously discussed that are more readily degraded at the formation temperatures and form acids useful as a fiber degrading accelerant may be used and formed into fibers that are used in combination with the polymer fibers. Such fibers may be sized, shaped and configured the same or similarly as discussed previously with respect to the polymer fibers.

In another embodiment, the fiber degrading accelerant materials are incorporated into the polymer fibers themselves. This may be accomplished through mixing, blending or otherwise compounding the fiber degrading accelerant materials with the base polymer used to form the polymer fibers before the polymers are extruded or otherwise formed into fibers. This may include any of the fiber degrading accelerant materials previously discussed provided they are capable of being mixed, blended or compounded with the base polymers prior to extrusion or the formation of the fibers. The additive materials to the fibers may be substantially uniformly distributed throughout the individual fiber matrix in this manner. Alternatively, the additive may be non-uniformly distributed throughout the fiber. Incorporating the fiber degrading accelerant into the fiber ensures that the degrading accelerant remains with the fibers in the treatment fluid and contributes to their degradation once in place. Particularly well suited for this application are the low temperature degradable polymer materials previously discussed above. In certain instances, the fiber degrading accelerant may be incorporated with the fiber by applying the degrading accelerant as a coating that is applied to the already formed polymer fibers.

In still another application, an encapsulating material may be used with the fiber degrading accelerant. The encapsulation allows for the controlled release of the active substance. In this way, degrading materials that are more active or cause more rapid degradation of the fiber materials may be used as the encapsulation contributes to the slow or delayed release of such materials. This may include acids, bases, oxidizers or other degrading accelerants that are more soluble in the aqueous fluids at the temperatures for which the polymers are used. Less soluble or slowly soluble materials may also be encapsulated, however. The encapsulating material may be selected and configured to provide the desired delay or controlled release of the fiber degrading accelerant. Different types of encapsulating materials may be used with the same or different accelerants. The encapsulated materials may also have different sizes and configurations.

As an example of an encapsulated degrading accelerant, oxidizers such as sodium bromate or diammonium peroxidisulhate may be encapsulated in copolymers of vinylidene chloride and methyl acrylate.

In use, the encapsulated accelerant is intermixed in the treatment fluid or portion thereof with the polymer fibers. Incorporated with the fiber system, the encapsulated degrading accelerant may be released in a delayed and progressive fashion, allowing a controlled and continuous degradation of the polymer fibers. The encapsulating enclosure may be selected and configured so that it releases the fiber degrading accelerant within the treatment fluid over a period of at least one (1) hour when at the formation temperature, more particularly from about one (1) hour to about 14 hours, still more particularly from about one (1) hour to about one (1) day. Such delay may also be provided by the degree of solubility of the encapsulated material. Thus, the desired control and delay may therefore be affected by a combination of the encapsulating material and the accelerant material itself.

In another embodiment, the polymer fibers are formed as bi- or multi-component fibers with other degradable polymers, such as those previously described. In such instances, the polymers are not blended or compounded together prior to extrusion but are coextruded or formed separately as separate components of the same fiber. This may accomplished, for example, by coextrusion where separate streams of each polymer component is directed from a supply source through a spinning head (often referred to as a “pack”) in a desired flow pattern until the streams reach the exit portion of the pack (i.e. the spinnerette holes) from which they exit the spinning head in the desired multi-component relationship. The formation of multi-component polymer fibers is described in U.S. Pat. No. 6,465,094, which is herein incorporated in its entirety for all purposes. The various components of the multi-component fibers may be arranged and configured in a variety of different configurations, such as sheath-core fibers with single or multiple cores, different layers, etc. Either of the polymer or the degradable polymer fiber degrading accelerant may be used as the core or sheath. In certain embodiments, the degradable polymer degrading accelerant forms the core or cores, with the polymer forming the sheath or outer layer. The multi-component fibers may be configured in the same overall shapes, sizes and configurations to those fibers previously described.

The amounts of fiber degrading accelerant used with any of the embodiments described may vary and may depend upon a variety of factors. These may include the specific environmental conditions of use (e.g. formation temperature, fluid pH, etc.), the type of accelerant used and its activity, the type of polymer used, etc. Typically, the amount of fiber degrading accelerant used with the polymer fibers being degraded will range in a weight ratio from about 2:1 to about 1:100 of accelerant to polymer, more particularly from 1:1 to about 1:20, and more particularly from about 1:2 to about 1:10. Thus, for example, a weight ratio of 1:1 for the accelerant/fiber may be used within the treatment fluid or the accelerant may compose 50% by weight of the fibers themselves, such as when it is incorporated into the polymer fiber or coextruded with the fibers to form multi-component fibers.

Any of the above-described techniques may be used for the delayed or controlled degradation of the polymer fibers. A combination of any or all of these techniques may be used in any given treatment as well.

The following examples serve to further illustrate the disclosure.

### EXAMPLES

The action of a temporary lost circulation prevention composition according to the present disclosure may be divided into two independent properties: (1) the ability of the fluid to plug openings; and (2) the ability of the fluid to degrade with time and temperature, thereby restoring permeability.

For all examples, the following base fluid was prepared: a water solution of guar at a concentration of 1.79 g/L+45.5 g/L SafeCARB™ 250 calcium carbonate particles, available from MI-SWACO, Houston, Tex., USA. The guar was SLB-ESL, available from Economy Polymers and Chemicals, Houston, Tex., USA.

### Example 1

A pump 101 was connected to a tube 102. The internal tube volume was 500 mL. A piston 103 was fitted inside the tube. A pressure sensor 104 was fitted at the end of the tube between the piston and the end of the tube that was connected to the pump. A slot assembly 105 was attached to the other end of the tube.

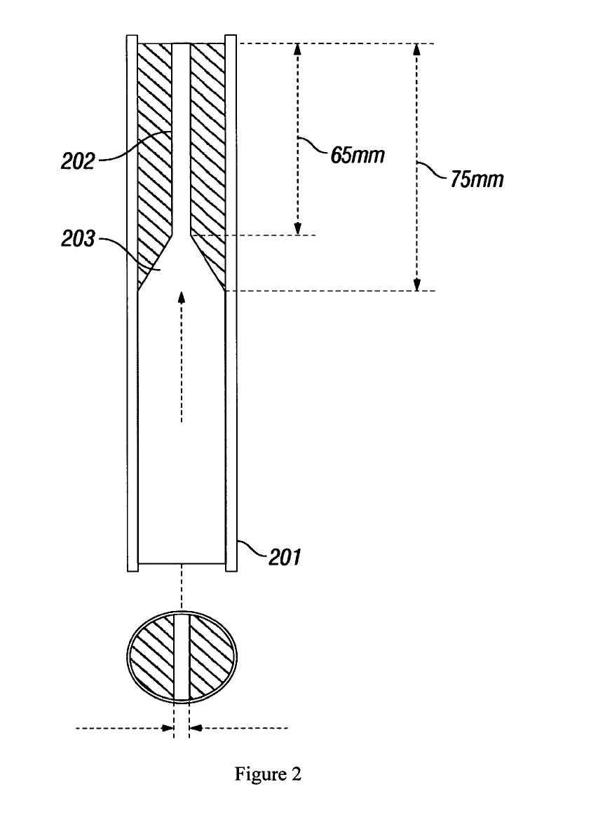

A detailed view of the slot assembly is shown in FIG. 2. The outer part of the assembly was a tube 201 whose dimensions are 130 mm long and 21 mm in diameter. The slot 202 was 65 mm long. Various slots were available with widths varying between 1 mm and 5 mm. Preceding the slot was a 10-mm long tapered section 203.

During the experiment, the test fluid was pumped through the 5-mm slot. If plugging took place, a rapid pressure rise was observed. The test terminated when the pressure began to approach the 34.5-bar (500-psi) limit.

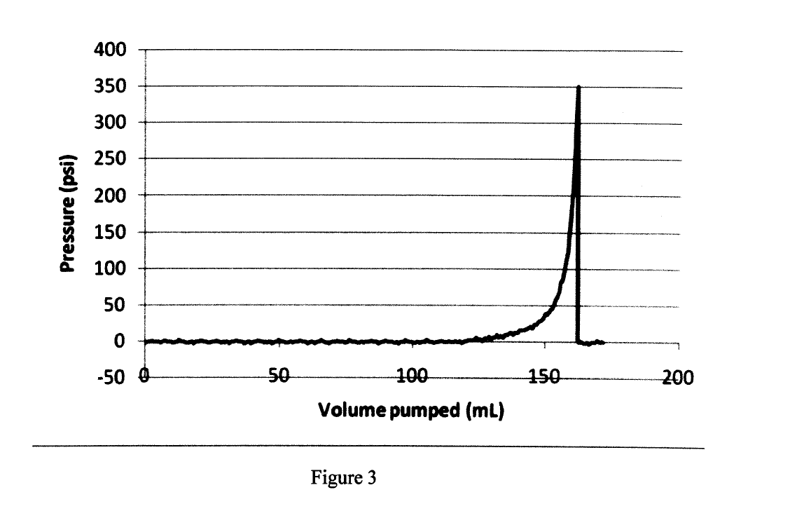

17.3 g/L of polylactic acid fibers (short cut 6 mm; 1.2 denier; available from Trevira GmbH, Germany) were added to 500 mL of base fluid. The remaining volume in the tube 102 was filled with water. The piston 103 was then added. Water was then pumped into the tube at a constant rate of 750 mL/min and pressure was monitored. During pumping, the fibers and particles formed an impermeable plug resulting in a rapid system-pressure rise to 34.5 bar and almost no leakage through the slot. A plot showing the evolution of pressure versus time is presented in FIG. 3.

### Example 2

An experiment was performed to evaluate the ability of the test fluid to plug downhole screens, which may be considered to be analogous to a lost circulation zone.

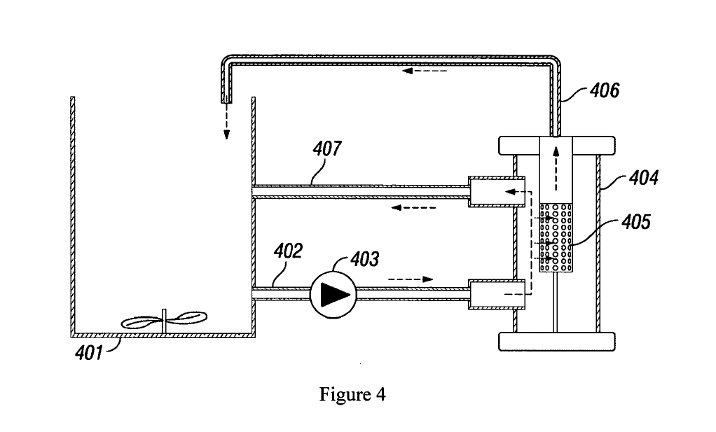

A schematic diagram of the test apparatus is shown in FIG. 4. A 1120-L (7 bbl) stirred mixing tank 401 was connected to a screen testing unit 404. The screen testing unit was a canister having a cylindrical screen 405 mounted therein. The hole size in the screen was 2 mm (10 US mesh). A centrifugal pump 403 transported the test fluid through a 10-cm (4-in.) line 402 and into the screen testing unit. Inside the screen testing unit, the fluid flowed through the screen or was excluded by the screen once an impermeable particle/fiber cake had formed around the screen. Fluid transiting the screen was transported back to the mixing tank via a 10-cm (4-in.) line 406. Fluid excluded from the screen was transported back to the mixing tank via a 10-cm (4-in.) line 407.

Nylon fibers (Nylon 6,6; short cut 6 mm, 1.0 denier, available from Barnet Europe, Germany) were added to the base fluid at a concentration of 5.7 g/L (2 lbm/bbl). The test fluid was pumped into the screen testing unit at 1140 L/min (300 galUS/min). Plugging of the screen was evidenced by a lack of fluid returning to the mixing tank via line 406. The time necessary to plug the screen was between 4 and 6 min.

### Example 3

An experiment was performed to evaluate the effect of fiber degradation on the permeability of a particle/fiber barrier fabricated according to the disclosure.

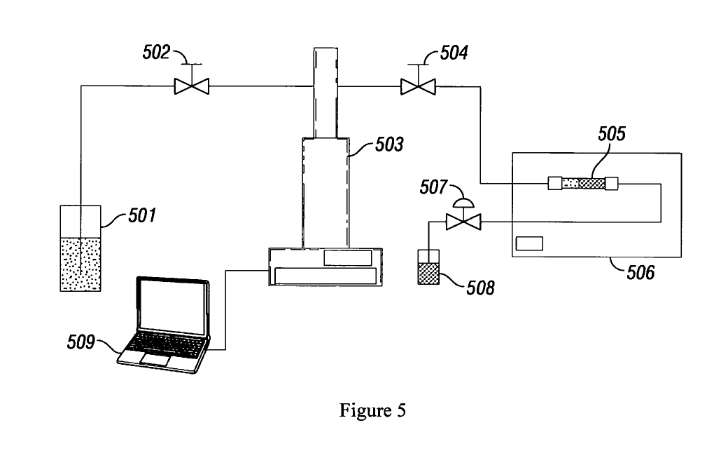

A schematic diagram of the test apparatus is shown in FIG. 5. A displacement fluid reservoir 501 is connected to a syringe pump 503 via a valve 502. Fluid exiting the syringe pump passes through a valve 504 until it reaches a 15-cm tube 505 fitted with a 250 micron (60 US mesh) screen at the exit end. The tube is enclosed inside an oven 506. Fluid exiting the slot passes through a valve 507 into a filtrate vessel 508. The test fluid is placed inside the 15-cm tube and is forced through the screen until plugging occurs. (Please correct this description as necessary). System pressure is monitored by a pressure transducer and recorded by a computer 509. The pressure readings are used to calculate the screen permeability using Darcy's Law.

Polylactic acid fiber (short cut 6 mm; 1.2 denier; available from Trevira GmbH, Germany) was added to the base fluid at a concentration of 17.1 g/L (6 lbm/bbl). The displacement fluid was pumped at a constant flow rate of 250 mL/min and the pressure was monitored. A sharp pressure increase occurred, indicating the accumulation of fibers and the formation of a plug. Then, displacement fluid was pumped and the flow rate was monitored. Starting at 3.5 MPa (500 psi), the system pressure was gradually increased to 6.9 MPa (1000 psi). The flow rate at 6.9 MPa fell to rate below 0.1 mL/min, corresponding to a plug permeability of approximately 1 mD.

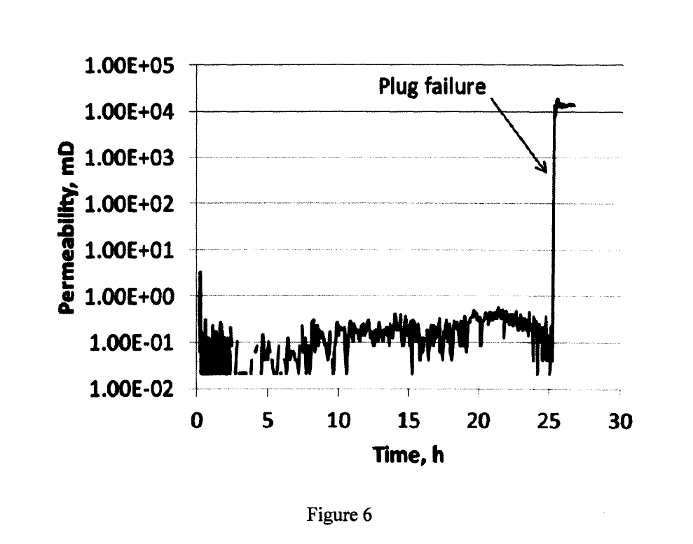

The oven was heated to 110° C. and the system pressure was maintained at 6.9 MPa. Minimal flow (<0.01 mL/min) was observed until suddenly, at 26 hours, the pressure dropped and flow commenced at a faster rate. After opening the tube, the remaining material was extracted and appeared to degrade into a powder when crushed manually. The calculated plug permeability versus time is shown in FIG. 6.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A method for temporarily blocking fluid flow through at least one pathway in a subterreanean formation penetrated by a wellbore, comprising:
(i) preparing a composition comprising water, at least one water soluble polymer, degradable particles or nondegradable particles or both, and degradable fibers;
(ii) placing the composition in the borehole such that the composition contacts the formation;
(iii) allowing the composition to flow into perforations, cracks, fissures, vugs or combinations thereof in the formation, thereby forming a filtercake or plug or both that restricts further flow of the composition into the formation;
(iv) allowing the fibers to degrade, thereby causing the plug or filtercake or plug or both to weaken; and
(v) removing the plug or filtercake or both, thereby reestablishing fluid movement between the wellbore and the formation.

2. The method of claim 1, wherein the water soluble polymer comprises guar, hydroxypropyl guar, carboxymethylhydroxyethyl guar, methylcellulose, ethylcellulose, hydroxyethylcellulose, hydroxypropylcellulose, xanthan gum, diutan gum, of polyacrylamide or combinations thereof.

3. The method of claim 1 or 2, wherein the particles are granular, lamellar or both, and are present at a concentration between 47 kg/m³ and 603 kg/m³.

4. The method of claim 1, wherein the particles comprise calcium carbonate, nut shells, plastics, sulfur, expanded perlite, cottonseed hulls, cellophane flakes, substituted and unsubstituted lactide, glycolide, polylactic acid, polyglycolic acid, a copolymer of polylactic acid and polyglycolic acid, a copolymer of glycolic acid with other hydroxy-, carboxylic acid-, or hydroxycarboxylic acid-containing moieties, a copolymer of lactic acid with other hydroxy-, carboxylic acid or hydroxycarboxylic acid-containing moieties, hydroxyacetic acid (glycolic acid) with itself or other hydroxy-, carboxylic acid-, or hydroxycarboxylic acid-containing moieties, polyvinyl alcohol, polyamide or polyethyleneterephtalate or combinations thereof.

5. The method of claim 1, wherein the particles have an average particle size (d₅₀) between 20 micrometers and 500 micrometers.

6. The method of claim 1, wherein the particles are present in at least two discrete groups, each having different average particle sizes.

7. The method of claim 1, wherein the fiber length is between 1 mm and 30 mm, and the fiber diameter is between 9 micrometers to 300 micrometers.

8. The method of claim 1, wherein the fibers comprise substituted and unsubstituted lactide, glycolide, polylactic acid, polyglycolic acid, a copolymer of polylactic acid and polyglycolic acid, a copolymer of glycolic acid with other hydroxy-, carboxylic acid-, or hydroxycarboxylic acid-containing moieties, a copolymer of lactic acid with other hydroxy-, carboxylic acid or hydroxycarboxylic acid-containing moieties, hydroxyacetic acid (glycolic acid) with itself or other hydroxy-, carboxylic acid-, or hydroxycarboxylic acid-containing moieties, polyvinyl alcohol, polyamide or polyethyleneterephtalate or combinations thereof

9. The method of claim 1, wherein the composition further comprises a fiber degradation accelerant, the accelerant being present at a concentration such that the accelerant:fiber weight ratio is between 1:1 and 1:100.

10. The method of claim 9, wherein the accelerant comprises a base that comprises calcium hydroxide, calcium oxide, magnesium hydroxide, magnesium oxide or zinc oxide or combinations thereof.

11. The method of any of claim 9 or 10, wherein the accelerant comprises an acid that comprises oleic acid, benzoic acid, nitrobenzoic acid, stearic acid, uric acid or fatty acids or combinations of derivatives thereof.

12. The method of claim 9, wherein the accelerant comprises an oxidizer that comprises a bromate, a persulfate, a nitrate, a nitrite, a chlorite, a hypochlorite, a perchlorate or a perborate or a combination thereof.

13. The method of claim 9, wherein the accelerant is encapsulated.

14. The method of claim 1, wherein the fibers pass through a drill bit and remain intact.

15. The method of claim 1, where in the treating is for controlling the movement of fluids in the subterranean well.
